(19) United States
(12) Patent Application Publication
(10) Pub. No.: US 2013/0250288 A1
(43) Pub. Date: Sep. 26, 2013

(54) GLASS SUBSTRATE INSPECTION DEVICE AND INSPECTION METHOD THEREOF

(71) Applicants: Erqing Zhu, Shenzhen (CN); Chun Hao Wu, Shenzhen (CN); Kun Hsien Lin, Shenzhen (CN); Yongqiang Wang, Shenzhen (CN); Weibing Yang, Shenzhen (CN); Xiande Li, Shenzhen (CN)

(72) Inventors: Erqing Zhu, Shenzhen (CN); Chun Hao Wu, Shenzhen (CN); Kun Hsien Lin, Shenzhen (CN); Yongqiang Wang, Shenzhen (CN); Weibing Yang, Shenzhen (CN); Xiande Li, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/510,378

(22) PCT Filed: Apr. 5, 2012
(86) PCT No.: PCT/CN2012/073506

§ 371 Date: May 17, 2012

(30) Foreign Application Priority Data
Mar. 22, 2012 (CN) 201210079294.2

(51) Int. Cl. G01N 21/88

(52) U.S. Cl. 356/239.1

(57) ABSTRACT

The present invention provides a glass substrate inspection device and an inspection method that are applicable to inspect if breaking exists in a glass substrate deposited in a cartridge. The inspection device includes at least one detector assembly and at least one processing unit. The detector assembly includes a light-transmitting element located at one side of the glass substrate and two light-receiving elements respectively located at two sides of the glass substrate. The processing unit determines if difference of brightness detected by the two light-receiving elements is within a predetermined range, whereby breaking is determined existing in the glass substrate when the difference of brightness is not within the predetermined range. With this arrangement, the present invention can reduce or prevent a broken glass substrate from entering a display panel manufacture line.

### BACKGROUND OF THE INVENTION

1. Field of the Invention

The present invention relates to the field of inspection, and in particular to a glass substrate inspection device and an inspection method thereof.

2. The Related Arts

Before entering a manufacturing line, a glass substrate that is used for a display panel of computer monitor or television is received in a cartridge for temporary storage. The cartridge is provided with a plurality of support surfaces in the vertical direction and each support surface supports one glass substrate. Thus, two adjacent glass substrates that are positioned in a cartridge are spaced from each other by a predetermined distance. Before the manufacture of display panels starts, automatic mechanical devices are employed to move a cartridge in which a plurality of glass substrates is positioned into the display panel manufacture line.

Since the distance between two glass substrates that are positioned on adjacent support surfaces of a cartridge is small, it is generally difficult to identify in the process of storage and conveyance if a glass substrate cracks or breaks. Conventionally, it is generally not possible to carry out an inspection operation to identify if a glass substrate breaks in the course from the glass substrate being deposited in a cartridge for temporary storage to the cartridge in which the glass substrate is deposited being moved by an automatic warehousing system into a display panel manufacture line and consequently, any broken glass substrate generated in the above course cannot be found until it enters the manufacture line. Thus, the broken glass substrate can only be removed in the display panel manufacturing process and this inevitably affects the manufacturing efficiency of the display panel. Further, a broken glass substrate may not be identified in time if the damage is minor and the broken glass substrate may then be used to make a display panel, which eventually becomes a disqualified product.

In view of this, it is desired to have a glass substrate inspection device and an inspection method thereof in order to overcome the above problem.

### SUMMARY OF THE INVENTION

The primary technical issue to be addressed by the present invention is to provide a glass substrate inspection device and an inspection method thereof, which are capable of inspecting if damages exist in glass substrate carried in a cartridge.

To address the above technical issue, the present invention adopts a technical solution by providing a glass substrate inspection device, which is applicable to inspecting if damage exists in a glass substrate deposited in a cartridge, wherein the inspection device comprises at least one detector assembly and at least one processing unit. The detector assembly comprises a light-transmitting element located at one side of the glass substrate and two light-receiving elements respectively located at two sides of the glass substrate. The light-transmitting element projects inspection light toward the glass substrate. One light-receiving element of the two light-receiving elements detects brightness of an inspection light component that is directly projected and/or that is reflected by the glass substrate, and the other light-receiving element of the two light-receiving elements detects brightness of an inspection light component that is refracted by the glass substrate. The processing unit determines if difference of brightness detected by the two light-receiving elements is within a predetermined range, whereby breaking is determined existing in the glass substrate when the difference of brightness is not within the predetermined range.

Wherein, the inspection device comprises a plurality of detector assemblies arranged in a vertical direction to simultaneously inspect a plurality of glass substrates that are supported in the cartridge in the vertical direction.

Wherein, the inspection device comprises a plurality of detector assemblies that are set in a horizontal direction in order to respectively inspect multiple areas of a horizontally set glass substrate.

Wherein, the light-transmitting element projects the inspection light in an inclined incidence manner toward the glass substrate.

Wherein, the light-transmitting element and the light-receiving elements are respectively set at opposite sides of the cartridge.

Wherein, the inspection device comprises an alarm unit, and the alarm unit issues an alarm message when the processing unit determines breaking exist in the glass substrate.

Wherein, the inspection device is installed at an entrance and/or an exit of an automatic warehousing system that warehouses the cartridge.

To address the above technical issue, the present invention adopts another technical solution by providing a glass substrate inspection device, which is applicable to inspect if breaking exists in a glass substrate deposited in a cartridge, wherein the inspection device is installed at an entrance and/or an exit of an automatic warehousing system that warehouses the cartridge. The inspection device comprises at least one detector assembly and at least one processing unit. The detector assembly comprises a light-transmitting element located at one side of the glass substrate and two light-receiving elements respectively located at two sides of the glass substrate. The light-transmitting element and the light-receiving elements are respectively set at opposite sides of the cartridge. The light-transmitting element projects inspection light toward the glass substrate. One light-receiving element of the two light-receiving elements detects brightness of an inspection light component that is directly projected and/or that is reflected by the glass substrate, the other light-receiving element of the two light-receiving elements detects brightness of an inspection light component that is refracted by the glass substrate. The processing unit determines if difference of brightness detected by the two light-receiving elements is within a predetermined range, whereby breaking is determined existing in the glass substrate when the difference of brightness is not within the predetermined range.

Wherein, the inspection device comprises a plurality of detector assemblies arranged in a vertical direction to simultaneously inspect a plurality of glass substrates that are supported in the cartridge in the vertical direction.

Wherein, the inspection device comprises a plurality of detector assemblies that are set in a horizontal direction in order to respectively inspect multiple areas of a horizontally set glass substrate.

Wherein, the light-transmitting element projects the inspection light in an inclined incidence manner toward the glass substrate.

Wherein, the inspection device comprises an alarm unit, and the alarm unit issues an alarm message when the processing unit determines breaking exist in the glass substrate.

To address the above technical issue, the present invention adopts a further technical solution by providing a glass substrate inspection method, which comprises: projecting an inspection light to a glass substrate; individually detecting brightness of an inspection light component that is directly projected and/or reflected by the glass substrate and brightness of an inspection light component that is refracted by the glass substrate; and determining if brightness difference between the brightness of the two inspection light components is within a predetermined range and determining that breaking exists in a glass substrate when the brightness difference is not within the predetermined range.

Wherein, the step of projecting an inspection light to a glass substrate comprises: projecting an inspection light in an inclined incidence manner toward the glass substrate.

Wherein, the inspection method further comprises issuing an alarm message when the breaking exists in the glass substrate.

The efficacy of the present invention is that an effective inspection can be made to determine if breaking exists in a glass substrate by means of a glass substrate inspection device and an inspection method thereof provided by the present invention, so as to prevent a broken glass substrate from entering a display panel manufacture line thereby reducing or avoiding removal of a broken glass substrate in the manufacturing process of display panel and thus improving the manufacturing efficiency of the manufacturing line and reducing the chance of using a broken glass substrate to make a display panel that eventually becomes a disqualified product.

### BRIEF DESCRIPTION OF THE DRAWINGS

FIG. 1 is a schematic view showing a glass substrate inspection device used to inspect a glass substrate according to the present invention;

FIG. 2 is a schematic view showing a glass substrate inspection device according to the present invention that comprises vertically arranged detector assemblies used to simultaneously inspect a plurality of glass substrates deposited in a cartridge according to the present invention;

FIG. 3 is a schematic view showing a glass substrate inspection device according to the present invention that comprises horizontally set detector assemblies used to inspect multiple areas of a horizontally set glass substrate; and

FIG. 4 is a flow chart illustrating a glass substrate inspection method according to the present invention.

### DETAILED DESCRIPTION OF THE PREFERRED EMBODIMENTS

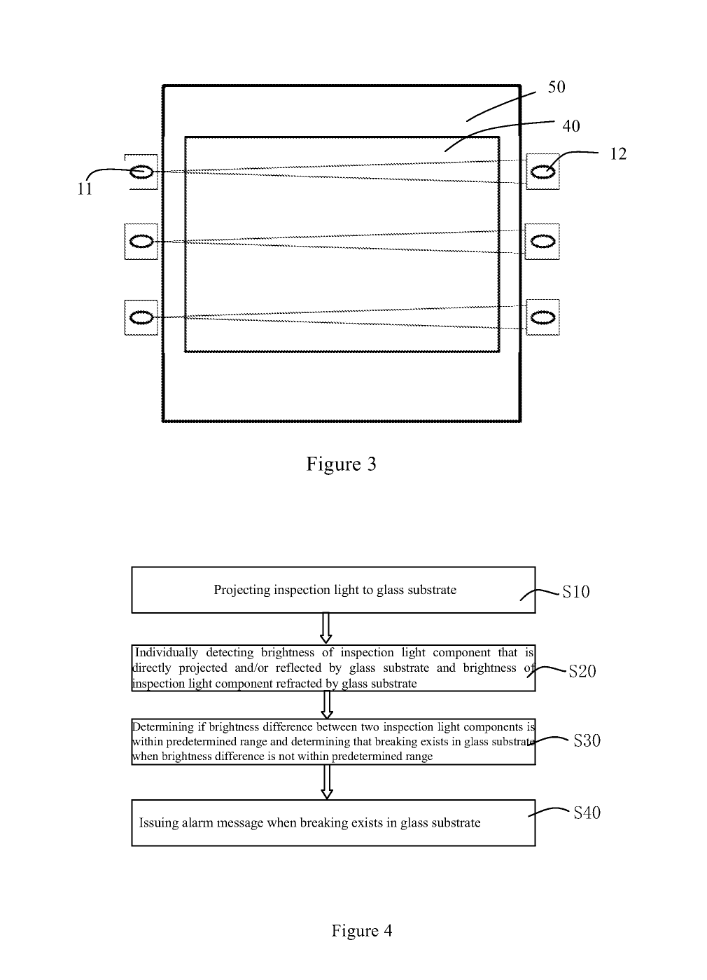

Referring to FIGS. 1-3, a glass substrate inspection device according to an embodiment of the present invention is applicable to inspecting if damage exists in glass substrates 40 that are temporarily positioned in a cartridge 50. The inspection device is capable of inspecting some or all the glass substrate 40 deposited in the same cartridge 50.

The cartridge 50 is provided for simultaneously carrying a plurality of glass substrates 40. The cartridge 50 comprises a plurality of support surfaces (not shown) that are arranged parallel to each other in the vertical direction. Each of the support surfaces supports one glass substrate 40. When the glass substrates 40 are received in the cartridge 50, adjacent ones of the glass substrates 40 are spaced from each other by a predetermined distance. In a practical application, to increase the number of glass substrates 40 received in a single cartridge 50, the spacing distance between adjacent glass substrates 40 is made small and, as a consequence, when the cartridge 50 is fully loaded with glass substrates 40, except the topmost one of the glass substrates 40, it is not possible to directly observe the surfaces of the remaining glass substrates 40. And, it becomes extremely difficult to identify if any breaking exists in those remaining glass substrates 40.

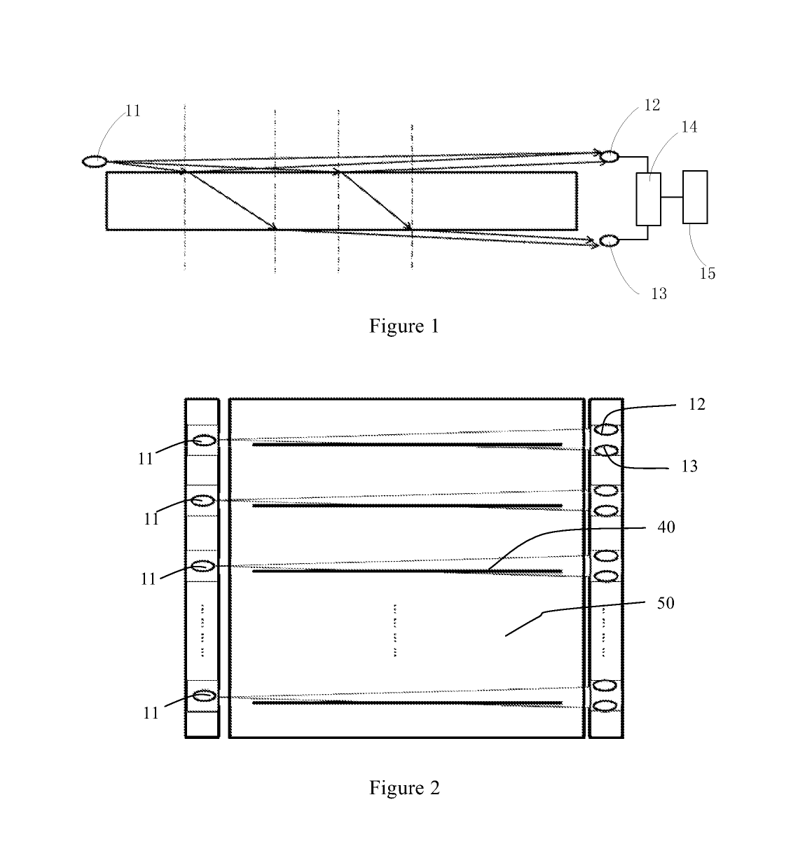

The glass substrate inspection device comprises at least one detector assembly, and each detector assembly comprises a light-transmitting element 11 and a pair of light-receiving elements 12, 13 respectively located at opposite sides of the cartridge 50. The glass substrate inspection device further comprises a processing unit 14. The glass substrate inspection device is capable of inspecting all the glass substrates 40 contained in a cartridge 50. Under this condition, a plurality of detector assemblies is arranged in the vertical direction to respectively and simultaneously inspect the glass substrates 40 contained in the cartridge 50, particularly as shown in FIG. 2. Further, to make the result of inspection more precise, for each glass substrate 40 that is set horizontally, the glass substrate inspection device may comprise three or any arbitrary number of detector assemblies that are arranged in the horizontal direction to respectively inspect different areas of the glass substrate 40.

To use, the light-transmitting element 11 is set at one side of the glass substrate 40 and the light-transmitting element 11 preferably projects an inspect light in an inclined incident manner to the glass substrate 40. The two light-receiving elements 12, 13 are respectively set at upper and lower sides of the glass substrate 40. The light-receiving elements 12, 13 receive the inspection light emitting from the light-transmitting element 11.

In the instant embodiment, the inspection light received by the light-receiving element 12 comprises a component that is directly coming from the light-transmitting element 11, while another component is emitted from the light-transmitting element 11 to an air-glass interface to be reflected thereby toward the light-receiving element 12. The inspection light received by the light-receiving element 13 is emitted from the light-transmitting element 11 to an air-glass interface and refracted by the glass substrate to eventually reach the light-receiving element 13. Thus, a difference of brightness between the brightness detected by the light-receiving element 12 and the brightness detected by the light-receiving element 13 is determined by the brightness issued by the light-transmitting element 11, the thickness and length of the glass substrate 40, the locations of the two light-receiving elements 12, 13, and any damage exists in the glass substrate 40.

In a practical operation, multiple tests are conducted on an intact glass substrate 40 in respect of factors including the brightness of inspect light issued from the light-transmitting element 11, the length and thickness of the glass substrate 40, and the locations of the two light-receiving elements 12, 13 in order to determine a normal range (predetermined range) of brightness difference in respect of the brightness detected by the two light-receiving elements 12, 13 for such a case that the glass substrate 40 is definitely confirmed to be intact and store the range in the processing unit 14. The glass substrate inspection device may then be used to inspect the glass substrates 40 contained in a cartridge 50. If the brightness difference between the two light-receiving elements 12, 13 is identified within the normal range, then it is determined that the glass substrate 40 is of no breaking. If the brightness difference between the two light-receiving elements 12, 13 exceeds the normal range, then it is determined that the glass substrate 40 breaks. The process of identification is performed by the processing unit 14 that is connected to the light-receiving elements 12, 13. In other embodiments, the light-receiving element 12 may only detect the inspection light directly coming from the light-transmitting element 11 or the inspection light that is reflected by the glass substrate 40.

In a practical application, the glass substrate inspection device may further comprise an alarm unit 15 that is connected to the processing unit 14. The processing unit 14 issues a control signal to the alarm unit 60 according to the result of identification so that the alarm unit 15 may issue an alarm message when the processing unit 14 determines the glass substrate 40 breaks. A cartridge 50 that contains a broken glass substrate is moved to a different site in order to prevent the broken glass substrate from entering the display panel manufacture line.

The glass substrate inspection device is applicable to following situations, the first of which is that when a glass substrate is positioned into the cartridge for temporary storage, the glass substrate inspection device is used to carry out inspection on the glass substrate received in the cartridge in order to determine if the packaging process of the glass substrate is problematic; the second is that when the cartridge that contains therein glass substrates enters an automatic warehousing system, the glass substrate inspection device that is installed at an entrance of the automatic warehousing system is employed to inspect the glass substrates received in the cartridge that enters the automatic warehousing system in order to intercept any cartridge that contains a broken glass substrate for easy identification of the cause of breaking of the glass substrate, the third is that when a glass substrate is to be put into the display panel manufacture line, the glass substrate inspection device installed at an exit of the automatic warehousing system carry out inspection on the glass substrate contained in a cartridge to be put into the display panel manufacture line in order to intercept the cartridge that contains a broken glass substrate and thus preventing the broken glass substrate from entering the display panel manufacture line to lower the manufacturing efficiency thereby preventing the broken glass substrate from being used to make a display panel that becomes a disqualified product.

The above discussed three situations may be all provided with individual glass substrate inspection device, or alternatively, the glass substrate inspection devices may be installed for one or two of these situations. No matter where the glass substrate inspection device is installed, it is possible to better reduce or prevent a broken glass from entering a display panel manufacture line when compared to the known technology.

Preferably, the entrance and exit of an automatic warehousing system are both provided with the glass substrate inspection device, for this helps identifying any problem occurring in the temporary storage of glass substrates and is also helpful in identifying no glass substrate is broken when the cartridge is moved by the automatic warehousing system. Both the glass substrate inspection devices installed at these two sites can intercept any cartridge that contains a broken glass thereby preventing the broken glass from entering the display panel manufacture line.

In the glass substrate inspection device according to the embodiment of the present invention, since a glass substrate 40 may have a great width, to more fully and more carefully inspect a surface of the glass substrate 40, three detection devices are provided for each glass substrate 40. The three detection devices have light-transmitting elements 11 that are located at the same side of the cartridge 50 and thus, pairs of light-receiving elements 12, 13 corresponding thereto are set at an opposite side of the cartridge 50.

In a practical operation, the number of detector assemblies that are employed to inspect the same glass substrate 40 may be modified according to the width of the glass substrate 40. When the width of the glass substrate 40 is small, a small number of detector assemblies are used to inspect a glass substrate 40, such as one or two detector assemblies being used to inspect a glass substrate. When the glass substrate 40 has a great width, more than three detector assemblies may be used to inspect the same glass substrate.

Further, when the number of the detection devices that are used to inspect a glass substrate 40 is greater than one, the light-transmitting element 11 and the pair of light-receiving elements 12, 13 of the detection device can be positioned in a different way. For example, the light-transmitting element 11 of a detection device is placed at one side of the cartridge 50 and the light-receiving elements 12, 13 corresponding to the detection device is set at an opposite side of the cartridge 50; and the locations of the light-transmitting element 11 and the light-receiving elements 12, 13 of the other detection device are reversed with respect to those of the previous detection device.

Besides the glass inspection device that is mentioned in the previous embodiment to inspect all the glass substrates 40 contained in a cartridge 50 at the same time, the glass inspection device according to the present invention is also applicable to simultaneously inspecting only some of the glass substrates 40 contained in a cartridge 50. For example, for a cartridge containing therein 3n pieces of glass substrate, the glass inspection device may be operable to inspect only n pieces of the glass substrates, and consequently, the glass substrates contained in the cartridge can only be completely inspection with three inspection operations. Under this condition, the light-transmitting element 11 and the light-receiving element 12, 13 can be mounted in a conveyance mechanism in order to be moved in the vertical direction to complete multiple operations of inspection.

In the embodiment of the present invention, the light-transmitting element 11 of the glass substrate inspection device is set at an upper side of an end of the glass substrate 40. However, practical operations are not limited to such an arrangement. The location of the light-transmitting element 11 can be at a lower side of the end of the glass substrate 40 or any other suitable location.

Referring to FIG. 4, an embodiment of the present invention provides a glass substrate inspection method, comprising the following steps:

S10: projecting an inspection light to a glass substrate, wherein the inspection light is preferably projected in an inclined incidence manner toward the glass substrate;

S20: individually detecting brightness of an inspection light component that is directly projected and/or reflected by the glass substrate and brightness of an inspection light component that is refracted by the glass substrate;

S30: determining if brightness difference between the brightness of the two inspection light components is within a predetermined range and determining that breaking exists in a glass substrate when the brightness difference is not within the predetermined range; and

S40: issuing an alarm message when the breaking exists in the glass substrate.

To be distinguished from the state of the art, the present invention provides a glass substrate inspection device and an inspection method thereof that are capable to effectively identify if breaking exists in a glass substrate and prevent a broken glass substrate from entering a display panel manufacture line thereby reducing or avoiding removal of a broken glass substrate in the manufacturing process of display panel and thus improving the manufacturing efficiency of the manufacturing line and reducing the chance of using a broken glass substrate to make a display panel that eventually becomes a disqualified product.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A glass substrate inspection device, which is applicable to inspect if breaking exists in a glass substrate deposited in a cartridge, wherein the inspection device comprises at least one detector assembly and at least one processing unit, the detector assembly comprising a light-transmitting element located at one side of the glass substrate and two light-receiving elements respectively located at two sides of the glass substrate, the light-transmitting element projecting inspection light toward the glass substrate, one light-receiving element of the two light-receiving elements detecting brightness of an inspection light component that is directly projected and/or that is reflected by the glass substrate, the other light-receiving element of the two light-receiving elements detecting brightness of an inspection light component that is refracted by the glass substrate, the processing unit determining if difference of brightness detected by the two light-receiving elements is within a predetermined range, whereby breaking is determined existing in the glass substrate when the difference of brightness is not within the predetermined range.

2. The inspection device according to claim 1, wherein the inspection device comprises a plurality of detector assemblies arranged in a vertical direction to simultaneously inspect a plurality of glass substrates that are supported in the cartridge in the vertical direction.

3. The inspection device according to claim 1, wherein the inspection device comprises a plurality of detector assemblies that are set in a horizontal direction in order to respectively inspect multiple areas of a horizontally set glass substrate.

4. The inspection device according to claim 1, wherein the light-transmitting element projects the inspection light in an inclined incidence manner toward the glass substrate.

5. The inspection device according to claim 1, wherein the light-transmitting element and the light-receiving elements are respectively set at opposite sides of the cartridge.

6. The inspection device according to claim 1, wherein the inspection device comprises an alarm unit, and the alarm unit issues an alarm message when the processing unit determines breaking exist in the glass substrate.

7. The inspection device according to claim 1, wherein the inspection device is installed at an entrance and/or an exit of an automatic warehousing system that warehouses the cartridge.

8. A glass substrate inspection device, which is applicable to inspect if breaking exists in a glass substrate deposited in a cartridge, wherein the inspection device is installed at an entrance and/or an exit of an automatic warehousing system that warehouses the cartridge, the inspection device comprising at least one detector assembly and at least one processing unit, the detector assembly comprising a light-transmitting element located at one side of the glass substrate and two light-receiving elements respectively located at two sides of the glass substrate, the light-transmitting element and the light-receiving elements being respectively set at opposite sides of the cartridge, the light-transmitting element projecting inspection light toward the glass substrate, one light-receiving element of the two light-receiving elements detecting brightness of an inspection light component that is directly projected and/or that is reflected by the glass substrate, the other light-receiving element of the two light-receiving elements detecting brightness of an inspection light component that is refracted by the glass substrate, the processing unit determining if difference of brightness detected by the two light-receiving elements is within a predetermined range, whereby breaking is determined existing in the glass substrate when the difference of brightness is not within the predetermined range.

9. The inspection device according to claim 8, wherein the inspection device comprises a plurality of detector assemblies arranged in a vertical direction to simultaneously inspect a plurality of glass substrates that are supported in the cartridge in the vertical direction.

10. The inspection device according to claim 8, wherein the inspection device comprises a plurality of detector assemblies that are set in a horizontal direction in order to respectively inspect multiple areas of a horizontally set glass substrate.

11. The inspection device according to claim 8, wherein the light-transmitting element projects the inspection light in an inclined incidence manner toward the glass substrate.

12. The inspection device according to claim 8, wherein the inspection device comprises an alarm unit, and the alarm unit issues an alarm message when the processing unit determines breaking exist in the glass substrate.

13. A glass substrate inspection method, comprising the following steps:
projecting an inspection light to a glass substrate;
individually detecting brightness of an inspection light component that is directly projected and/or reflected by the glass substrate and brightness of an inspection light component that is refracted by the glass substrate; and
determining if brightness difference between the brightness of the two inspection light components is within a predetermined range and determining that breaking exists in a glass substrate when the brightness difference is not within the predetermined range.

14. The inspection method according to claim 13, wherein the step of projecting an inspection light to a glass substrate comprises: projecting an inspection light in an inclined incidence manner toward the glass substrate.

15. The inspection method according to claim 13, wherein the inspection method further comprises issuing an alarm message when the breaking exists in the glass substrate.
